(19) United States
(12) Patent Application Publication
(10) Pub. No.: US 2007/0241259 A1
(43) Pub. Date: Oct. 18, 2007

(54) Room light responsive cabinet lighting apparatus

(76) Inventors: Robert Pandorf, Yardley, PA (US); James L. Stanley, Bristol, PA (US); Paul J. Briggs, Bristol, PA (US)

Correspondence Address: QUARLES & BRADY LLP, 411 E. WISCONSIN AVENUE, SUITE 2040, MILWAUKEE, WI, 53202-4497, US

(21) Appl. No.: 11/406,224

(22) Filed: Apr. 18, 2006

(51) Int. Cl. H05B 37/02

(52) U.S. Cl. 250/214 AL

(57) ABSTRACT

A cabinet light apparatus has a light source that is controlled according to ambient light conditions in the room where the cabinet is mounted, such as a kitchen or bathroom. The cabinet has a door and a light source positioned on the door. A sensor detects light levels present on the door and activates the light source upon detection of a pre-determined low light level. Once activated, the apparatus is configured such that light is projected outwardly from the door. When the cabinet door is open, the light source also projects upwardly to illuminate portions of the interior of the cabinet. The cabinet light is deactivated after the ambient light level surpasses the pre-determined level.

### CROSS-REFERENCE TO RELATED APPLICATIONS

Not applicable.

### STATEMENT OF FEDERALLY SPONSORED RESEARCH/DEVELOPMENT

Not applicable.

### BACKGROUND OF THE INVENTION

Automatic lighting systems are typically used in conjunction with motion sensors and the like so as to turn on the lights when human or other presence is detected. Other automatic lighting systems, such as yard lights, are activated by ambient light levels. Lighting systems of this sort are especially beneficial in low light environments. However, cabinet systems, particularly those in kitchens and bathrooms which would benefit from a lighting system that is activated in low ambient light conditions, typically do not incorporate lighting systems of this kind.

Further, kitchen and bathroom cabinets are often built to maximize the available space to provide the most storage area possible. To accomplish this, cabinets are often constructed to be particularly deep or wide, especially in corner cabinet units. While such designs provide greater storage space, they often hamper access to shelf contents. Items on a shelf may need to be moved to allow access to another item. In addition, it is often desired to quickly remove something from a cabinet without turning on the overhead lights in that room.

U.S. Pat. No. 4,979,308 describes a can opener and night light appliance comprising an under-the-cabinet kitchen appliance that functions as an automatic electric can opener and an automatic night light. The appliance includes a housing for the automatic electric can opener integral with a night light bulb housing. The electric circuit for the night light and the can opener are integrated and may include a light responsive device so that the light bulb is energized during periods of low room illumination and de-energized during periods of high room illumination. However, it is not practical to use multiple can-opening units to illuminate every shelf in every cabinet in a kitchen since the can opener feature limits this device to use on a single cabinet.

Therefore, a need exists for a cabinet lighting apparatus employing an ambient light responsive light that illuminates both the immediate exterior of the cabinet as well as areas of the interior of the cabinet when the cabinet is opened.

### BRIEF SUMMARY OF THE INVENTION

In one aspect the invention provides a cabinet lighting apparatus comprising a cabinet having at least one door in proximity to one wall; a light source, preferably positioned on a lower edge of the door; and a sensor. The sensor detects light levels present at an exterior of the door for activating/deactivating the light source according to detection of a pre-determined level of low light ambient conditions. Once activated, the apparatus is configured such that light is projected outwardly from the door. When the cabinet door is open, the light source also illuminates areas of the interior of the cabinet.

The light source is preferably positioned along the entire length of the lower edge of the cabinet door. However, in alternate versions, the light can be positioned along any portion of the cabinet door.

In a preferred version the light source of the present apparatus is a light emitting diode (LED). However, the apparatus may also feature lights from a variety of sources, including but not limited to incandescent lamps, electro-luminescent shapes, fluorescents, fiber optics, liquid crystal display (LCD) and glowing plastics or organic light emitting diodes.

The sensor is preferably an ambient light sensor such as a photoelectric sensor. In a preferred version the sensor is operable to detect even low levels of ambient light. In one embodiment of the invention, the spectral sensitivity of the ambient light sensor is chosen to approximate the spectral intensity of the human eye and to have continuous sensitivity through a wide range of viewing angles.

In a further embodiment, the ambient light sensor preferably generates an electrical signal in response to received ambient light and compares the electrical signal to a threshold level to determine if ambient light is present. The threshold level is preferably chosen such that even low levels of ambient light are detected. The ambient light sensor may be operated intermittently or continuously.

The sensor is preferably operably connected to the light source such that when the pre-determined levels of darkness are detected by the sensor, the light source is activated.

The sensor and light source are preferably controlled by controls positioned within the interior of the cabinet. The controls preferably allow a user to dictate the desired light levels as well as the intensity of the light once activated. The controls can be of any kinds known to the art.

In a preferred version the apparatus is electrically operated. Alternatively, the apparatus may operate from a battery during usage.

The foregoing and other advantages of the present invention will be apparent from the following description. In the description that follows reference is made to the accompanying drawings which form a part thereof, and in which there is shown by way of illustration, and not limitation, expected preferred embodiments of the invention. Such embodiments do not necessarily represent the full scope of the invention, and reference should therefore be made to the claims herein for interpreting the scope of the invention.

### BRIEF DESCRIPTION OF THE DRAWINGS

FIG. 1 is a perspective view of the cabinet lighting apparatus of the present invention;

FIG. 2 is a perspective view of the cabinet of FIG. 1 with the door opened; and

FIG. 3 is a rear cut-away view showing the interior of the door of the cabinet of FIGS. 1 and 2.

### DETAILED DESCRIPTION OF THE PREFERRED EMBODIMENTS

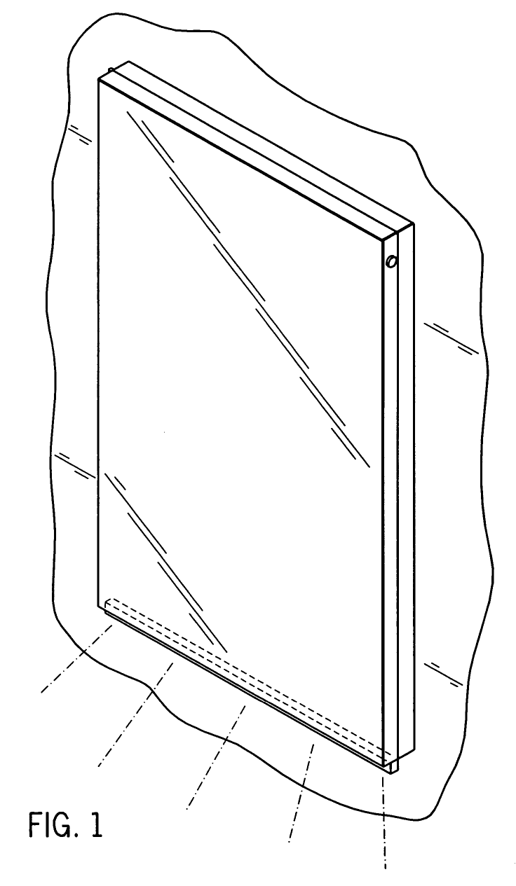

Referring to FIGS. 1-3, a preferred embodiment of room light responsive cabinet lighting apparatus 10 of the present invention is shown. As seen in FIG. 1, the apparatus 10 comprises a wall-mounted cabinet 12 having at least one door 14 in proximity to a wall 16.

In a preferred version the cabinet 12 is a medicine cabinet hung over a sink. Hence, the directional terms in this patent are used with that type of installation in mind. However, the apparatus 10 may also be used in combination with other cabinet systems, including kitchen cupboards, linen closets, or other storage cabinets. Thus, terms such as “front”, “rear”, “upper”, “lower”, and “side” should be interpreted in an analogous manner when the apparatus 10 is used for a given type of installation.

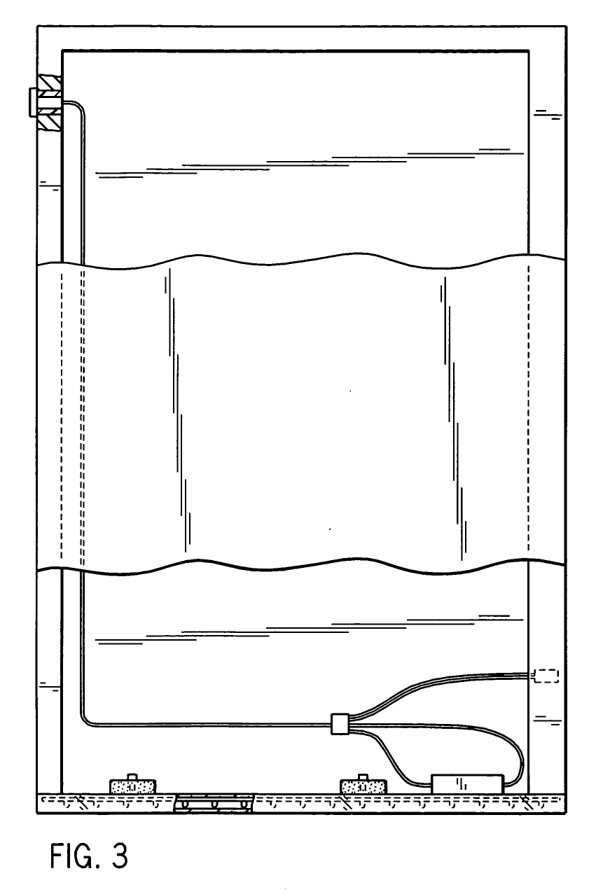

A light source 18 is preferably positioned along the lower edge 20 of the door 14. In a preferred version the light source 18 comprises an LED board with sensor. The light 18 is preferably mounted to the lower edge 20 of the door 14 via a plurality of mounting blocks 32 (see FIG. 3). In a further version, the light source 18 may be protected by a translucent plastic cover (not shown). For instance, a preferred version of the apparatus comprises low powered (12 Vdc) LEDs and sensor circuit.

A sensor 22 is also positioned on the door 14. Although a preferred position of the sensor 22 is seen if FIG. 1 (i.e., the top corner of the door 14) other positions of the sensor 22 are acceptable. The sensor 22 is preferably operably connected via wire 23 to the light source activation sensor 28 (see FIG. 3).

For instance, a preferred version of the apparatus is powered by a transformer (120 Vac to 12 Vdc) which is powered electrically via hard wired line power (120 Vac) to the apparatus 10.

The sensor 22 is preferably electrically operated and powered by connection to an electrical outlet (not shown). For instance, the sensor wire 23 may contain an electrical plug 30 at one end (see FIG. 3). The plug 30 is preferably capable of plugging into any standard outlet (not shown).

In use, the sensor 22 measures the ambient light in and around the apparatus 10 and compares the detected light levels to a pre-determined level of darkness set by the controls 24. Once the detected light is determined to be lower than the pre-determined level, the light source 18 is activated. Once activated, the light source 18 projects a pre-determined intensity of light outwardly from the apparatus 10. When the detected light is higher than the pre-determined level, the light source 18 is deactivated.

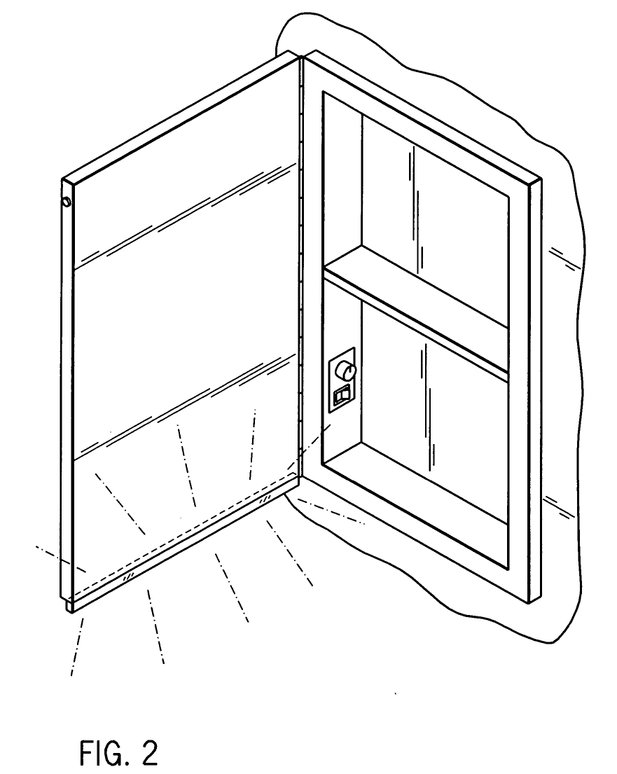

Referring now to FIG. 2, an interior view of the cabinet 12 is shown. The cabinet preferably houses the controls 24 which allow a user to pre-determine the levels of darkness required to activate the light source 18 as well as the intensity of light emitted from the light source 18 upon activation.

In a preferred version the controls 24 comprise two parts. A toggle switch 24A allows a user to turn on or off the power to the apparatus. A knob 24B allows the user to determine the level(s) of ambient light required to turn on and off the light source 18. This knob 24B can also allow the user to determine the intensity (brightness) of the light source 18 when activated. In alternate versions, this can be a separate control (not shown).

In a further preferred version, the light sensor 28 may be fixed to activate at a set level of illumination without variable control. Additionally, the intensity of the LEDs may be set at a certain level of illumination and will not be adjustable.

In use then, once activated, the light source 18 not only projects light outwardly from the cabinet 12, but also provides illumination for at least portions of the interior 26 of the cabinet 12 when the door 14 is opened.

FIG. 3 shows the operable connection between the sensor 22 and the light source 18. In a preferred version the connection between the sensor 22 and light source 18 is housed within the door 14. Thus, FIG. 3 illustrates the interior of the door 14.

While preferred embodiments of the present invention have been described above, it should be appreciated that the invention could be used in a variety of other embodiments.

Thus, the principles of the present invention can be applied in a variety of other ways apart from those specifically noted herein and/or depicted in the drawings. Still other modifications may be made without departing from the spirit and scope of the invention. Thus, the claims (rather than just the preferred embodiments) should be reviewed in order to understand the full scope of the invention.

### INDUSTRIAL APPLICABILITY

The present invention provides a cabinet lighting apparatus that responds to ambient light levels to illuminate both the immediate exterior of the cabinet as well as areas of the interior of the cabinet when the cabinet is opened.

We claim:

1. A cabinet lighting apparatus, comprising:
a cabinet having at least one door in proximity to one wall;
at least one light source positioned on the door; and
a sensor detecting a light level at the door;
wherein the light source is activated upon detection of a pre-determined level of low light such that the light source illuminates an area external to the cabinet and, when the door is opened, illuminates an internal area within the cabinet.

2. The apparatus of claim 1, further comprising a control for setting the desired light levels and for setting intensity of the light source.

3. The apparatus of claim 2, wherein the control is positioned within the cabinet.

4. The apparatus of claim 1, wherein the light source is a light emitting diode.

5. The apparatus of claim 1, wherein the light source is positioned on a first lower edge of the door.

6. The apparatus of claim 1, wherein the sensor is positioned on the door.

7. The apparatus of claim 1, wherein the sensor is an ambient light sensor.

8. The apparatus of claim 7, wherein the sensor has a light spectral sensitivity that approximates that of the human eye.

9. The apparatus of claim 1, wherein the light source is deactivated when a detected light level is above the pre-determined level of low light.

10. A cabinet lighting apparatus for providing illumination around and within areas of a cabinet having at least one door in proximity to one wall, the apparatus comprising:
at least one light source positioned on a lower edge of the door;
a sensor positioned on the door, wherein the sensor detects light levels present at the door for activating the light source upon detection of a predetermined level of low light; and
a control positioned within the cabinet, wherein the control determines the intensity of the light once activated and the amount of light required for activation;
wherein the apparatus is configured such that once activated, the light source illuminates an area external to the cabinet and, when the door is open, illuminates an interior of the cabinet.

11. The apparatus of claim 10, wherein the light source is a light emitting diode.

12. The apparatus of claim 10, wherein the sensor is an ambient light sensor.

13. A cabinet lighting apparatus for providing illumination around and within portions of a cabinet having at least one door in proximity to one wall, the apparatus comprising:
a light emitting diode positioned along the length of a lower edge of the door;
an ambient light sensor positioned on the door, wherein the sensor detects light levels present at an exterior of the door for activating the light source upon detection of a pre-determined level of low light;
a first control positioned within the cabinet, wherein the control determines the intensity of the light once activated; and
a second control positioned within the cabinet, wherein the control determines the amount of light required for activation;
wherein the apparatus is configured such that once activated, the light source illuminates an area external to the cabinet and, when the door is open, illuminates an interior of the cabinet.
